(19) United States
(12) Patent Application Publication
(10) Pub. No.: US 2003/0008097 A1
(43) Pub. Date: Jan. 9, 2003

(54) Enhanced ballistic protection material

(76) Inventors: Sharon Durst, Sacramento, CA (US); Ricardo Almanza, Davis, CA (US)

Correspondence Address: Mark C. Jacobs, Esq., 3033 El Camino Avenue, Sacramento, CA, 95821, US

(21) Appl. No.: 09/884,656

(22) Filed: Jun. 20, 2001

(51) Int. Cl. B32B 3/10

(52) U.S. Cl. 428/54

(57) ABSTRACT

A method and product for achieving high levels of ballistic protection from the use of a series of lower level (Level 1, 2, & 3) UL listed ballistic fibreglass sheets installed in a specific manner is disclosed. The ballistic fibreglass sheets are laid up in a staggered order without the use of battens thus achieving a significant cost savings.

### FIELD OF THE INVENTION

This patent application pertains to the provision of improved low cost bullet resistant materials for use in architectural locations.

### BACKGROUND OF THE INVENTION

The use of bullet resistant barriers to protect persons who work in violence prone arenas against intrusions, robbery and burglary are well documented. As used in this patent application, the term bullet resistant signifies that protection is provided against complete penetration, passage of fragments of projectiles, or spalling (fragmentation) of the protective material to the degree that an injury would be caused to a person who is standing directly behind the bullet resistant barrier. Thus such establishments as a bank's teller station, check cashing counter, certain counters and other areas in jewelry stores, and package passers all need such protection. To be successful in the marketplace, such ballistic resistant materials must also be free of risk from fire, electric shocking, noxious fumes to be acceptable to the marketplace.

But in order to be marketable at a profit, the material must not be the subject of high shipping costs even as it meets all of the other criteria enumerated. Bullet resistant materials are judged according to their ability to resist penetration. Thus, Underwriters Laboratory Bulletin #752 provides 8 Levels of resistance designated Levels 1-8 for ballistic resistant materials. On the low end, Level 1 materials are resistant to 9 mm full metal copper jacket lead core bullets, as well as bullets from other hand guns such as the 38 Automatic. Whereas Level 6 materials provide protection against multiple shots from a 9 mm Uzi submachine gun. Level 8 materials are resistant to 7.62 mm Rifle lead core bullets such as from the M-14 military assault rifle.

One material that enjoys acceptance in the marketplace is bullet resistant fibreglass. This material available in sheets can be incorporated into architectural products for use in bank teller areas, court room areas including judge benches, money handling rooms such as at casinos, cashier areas such as self-serve gas stations and convenience markets among many others. As criminals have become bolder and more apt to have more powerful weapons, business establishments have had to increase their levels of protection. But this comes at a cost, not just one cost but several. The use of increased thicknesses of fibreglass rated beyond Level 1 protection comes with significant weight increases, increased shipping costs, and increased installation costs due to more laborers needed to carry out the installation. These monolithic panels of fibreglass are all made from pluralities of plies of woven fibreglass impregnated with a resin a thermosetting resin, usually a polyester and then heat pressed in thicknesses ranging from ¼ inch to 1.375 inches. The more plies, the thicker the monolith panel, the heavier the panel for a given size such as 4′×8′, and the higher the level of protection available from that panel.

Therefore there has developed a need for finding a way to achieve a higher level of bullet resistant protection without the normally anticipated increase in weight, thickness and installation charges associated with the user of higher level individual fibreglass panels.

The invention accordingly comprises the device possessing the features properties and the relation of components which are exemplified in the following detailed disclosure and the scope of the application of which will be indicated in the appended claims.

For a fuller understanding of the nature and objects of the invention reference should be made to the following detailed description, taken in conjunction with the accompanying drawings.

### SUMMARY OF THE INVENTION

This invention is based upon the discovery that upper levels of ballistic protection can be had from combining a plurality of layers of lower level protection ballistic fibreglass panels in certain combinations to achieve the level of protection normally associated with a single monolithic thickness of higher level protection ballistic fibreglass.

Combinations of Level 1, Level 2, and Level 3 ballistic fibreglass panels are combined together to achieve the bullet resistance of Levels 5, 6, 7, and 8 of ballistic fibreglass. By combining thicknesses to meet the Underwriters Laboratory specification of what constitutes a certain level of protection, applicant can save labor costs, time, and achieve a better installation in that the sheer physical space taken up by the armour is less than when the ballistic protection is carried out according to the prior art. This combination of lower level ballistic fibreglass must be carried out with the panels being set forth in a staggered arrangement such that the possibility of penetrating a “seam”—defined as the interface of two opposed edges of adjacent panels—all the way through the several sheets of fibreglass at this junction is avoided. As used here the word adjacent means laterally abutting as well as vertically abutting. The actual mode of abutment will be determined by the configuration of the zone of protection (protection zone). Within this protection zone, the interior thereof is the face closest to the persons being protected. In a bank the interior of the zone would be where the tellers are.

It is a first object of this invention to provide a procedure for combining sheets of lower level of protection ballistic fibreglass to achieve the level of protection associated with a thicker monolithic single sheet or panel rated at a higher level of protection.

It is a second object to provide a product that has the bullet resistant characteristics of higher level ballistic fibreglass by employing a series of lower level of protection sheets of ballistic fibreglass in architectural environments.

It is a third object of this invention to provide a mode of installing ballistic fibreglass armour without the need for fibreglass battens, thereby diminishing the space occupied by the armour.

It is a fourth object to provide a labor cost saving method of achieving high levels of ballistic protection.

It is a fifth object to provide a freight cost saving method of achieving high levels of ballistic protection from ballistic fibreglass.

Other objects of the invention will in part be obvious and will in part appear hereinafter.

### BRIEF DESCRIPTION OF THE FIGURES

FIG. 1 is a perspective view of a prior art wall installation of ballistic fibreglass.

FIG. 2 is a top plan view of the mode of installation of ballistic fibreglass according to the prior art.

FIG. 3 is a perspective view of the installation of ballistic fibreglass according to this invention.

FIG. 4 is a top plan view of the mode of installation of ballistic fibreglass according to this invention.

FIG. 5 is a top plan view showing the lay-up of three lower level layers of fibreglass according to this invention to reach a ballistic Level 4 of protection.

FIG. 6 is a top plan view showing the lay-up of three lower level layers of fibreglass according to this invention to reach a ballistic Level 4 of protection.

FIG. 7 is a top plan view showing the lay-up of five lower level layers of fibreglass according to this invention to reach a ballistic Level 5 and above of protection.

FIG. 8 is a top plan view showing the lay-up of four lower level layers of fibreglass according to this invention to reach a ballistic Level 5 and above of protection.

### DESCRIPTION OF THE PREFERRED EMBODIMENT

In order to protect certain types of workers, as our society has become more violent, businesses have turned to ballistic protection materials. It is deemed business-wise inappropriate for workers to have to wear a bullet proof vest to do a job such as a bank teller, check cashier or to work at a gas station collecting cash payments. Therefore, other modes of safeguarding the lives of certain workers prone to violence have arisen. One such mode is the installation of ballistic protective walls. Such installations are used in certain retail environments and in highly strategic business environments. More often than not, the casual viewer is unable to discern the presence of ballistic protection. Of course, the retail customer can see the special glass or acrylic installed at an installation, where viewing of persons on the opposite side of a boundary is necessary. But customers cannot discern the presence of armaments behind the gypsum wall disposed from counter height to the floor. Typical of such installations are judge benches, guard stations, safe rooms, hotel lobby areas, convenience stores, hospitals, fast food outlets etc., where the mental temperament of persons entering is unknown, or the handling of money takes place.

Different degrees of protection have been established and indeed Underwriters Laboratory (hereinafter UL) has established standards for various degrees of protection. Thus resistance by a wall to a bullet from a 45 mm gun is at a lower level than if the wall could not be penetrated by shots from a high-powered rifle. These differences are designated as Levels of Protection.

Thus, a UL Level 1 armament is supposed to be impenetrable by a 9 mm 124 gr. lead shell, while a UL Level 3 zone of protection requires resistance to a .44 MAG 240 grain shell, and a UL Level 4 zone protects against a .30 caliber shell as used in high-powered rifles. The higher the UL level the more resistant is the armour material.

For the purposes of this discussion, it is to be assumed and it is known in the prior art that the higher the level of ballistic protection associated with a sheet of ballistic fibreglass the thicker it will be. Ofttimes, the word panel is applied to these thicker sheets of fibreglass. It is known to the art that in order to achieve a Level 5 ballistic protection for example, according to the standard defined by Underwriters Laboratory, a series of ballistic tests must be carried out such that the predefined type of bullets do not penetrate a panel of ballistic fibreglass of a predefined thickness. Thus, to achieve Level 5 protection, a single panel of fibreglass (having multiple plies), which weighs 432 lbs., need to resist a set number of a specific bullet fired at the single sheet of fibreglass. The same is true for Level 8. This single sheet of Level 8 ballistic fibreglass, in a standard 4′×8′ size, weighs approximately 464 lbs. Thus, the benefits of this invention are readily seen. For any given architectural protected zone installation a plurality of these single panels of Level 5 or Level 8 fibreglass are installed adjacent to each other in a line by a work crew.

Therefore, for almost all installations such as, banks, check cashing locations, and other protected areas, it is necessary to abut a plurality of sheets adjacent to each other in a row to form the architectural protection zone of the particular establishment since sheets come mainly in a 4′×8′. configuration. Of course, other sheet sizes are available but to a lesser degree such as, 3′×8′, 4′×9′, and 4′×10′. For aesthetics, the protection zone is usually overlaid at least on the face toward customers and sometimes with overlays on both faces of the armoured area with common building materials such as, sheet rock and paint, wood paneling or high pressure laminate such as Formica®. Unfortunately, none of these overlaid materials provide any ballistic resistance and thus are classified as decorative only.

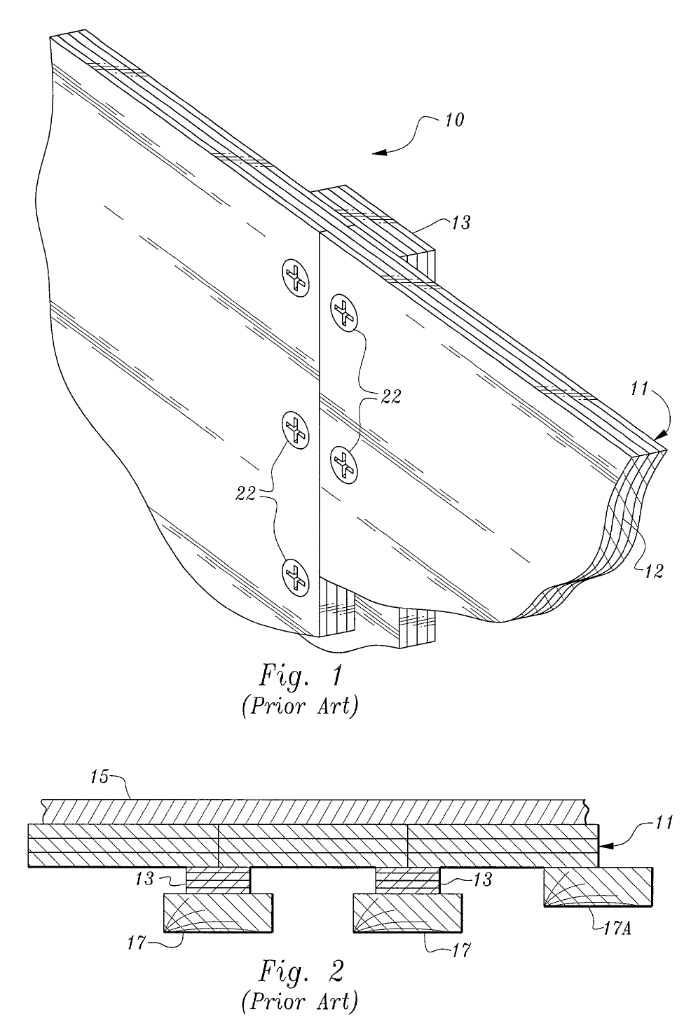

For example, the area to be protected may have a linear frontage of approximately twelve feet which would require three four foot wide vertical sheets to be placed side by side. The problem arises that a shooter could fire bullets that would be aimed intentionally or unintentionally at the junction between any two adjacent sheets. Such bullets would pass through the junction of the abutted fibreglass sheets. Therefore, the prior art practice that has been used as per FIG. 1 is to use a batten of the same level of protection behind the two multi-ply abutted fibreglass sheets. Therefore, should a shooter be able to accidently or purposely pass his/her bullets right between the junction of two adjacent sheets, the level of protection would still be obtained because the bullets would be stopped by the batten that is disposed behind and along the seam of the abutted sheets. See FIG. 1 wherein 10 represents a prior installation of abutted panels 11 to a batten 13. The monolith is constructed of a plurality of plies 12 of the resin impregnated fibreglass. Designator 22 signifies each of the conventional screws of the industry used to secure the adjacent panels to the batten of the same level of protection. Battens 13 are made of fibreglass.

In FIG. 2, a prior art installation of ballistic fibreglass protection is again illustrated. Here a thick monolithic panel 11 weighing over 400 lbs. is seen to be attached to the battens 13 with a stud 17 disposed behind the batten 13. Another known mode of stud placement is shown by the presence of stud 17A which is disposed lateral to the batten 13 instead of behind the batten 13.

Applicant has found that by abutting sequentially a plurality of sheets of a lower level protection ballistic fibreglass, in various combinations of Level 1, Level 2 and Level 3, and staggering the disposition of the plurality of horizontal sheets from layer to layer as far as placement is concerned, that the desired level, be it Level 4, 5, 7 or 8, but not Level 6 protection, can be achieved. In conjunction with the staggering of the placement of the individual lower level sheets, the penetration of bullets that might ordinarily pass through each sheet individually does not pass through a series of superposed sheets where the sum of thicknesses of the plurality equals or exceeds the thickness of the respective individual monolithic panel rated for the same level of protection. This is true at any point on the multi-sheet wall including the adjacent edge abutment of two sheets of the ballistic fibreglass.

Therefore, applicant has been able to do away with the necessity of using a batten behind the plurality of sheets of lower level ballistic fibreglass that are sequentially stacked to achieve the higher level of ballistic protection. The ability to carefully aim bullets or inadvertently aim bullets to pass through the abutted junction of two adjacent sheets of ballistic fibreglass, in order to penetrate into the protection zone, has been eliminated since the bullet could only pass between the first layer of abutted sheets since the seam—as defined previously elsewhere-laterally speaking and not through the second layer along the length of the wall.

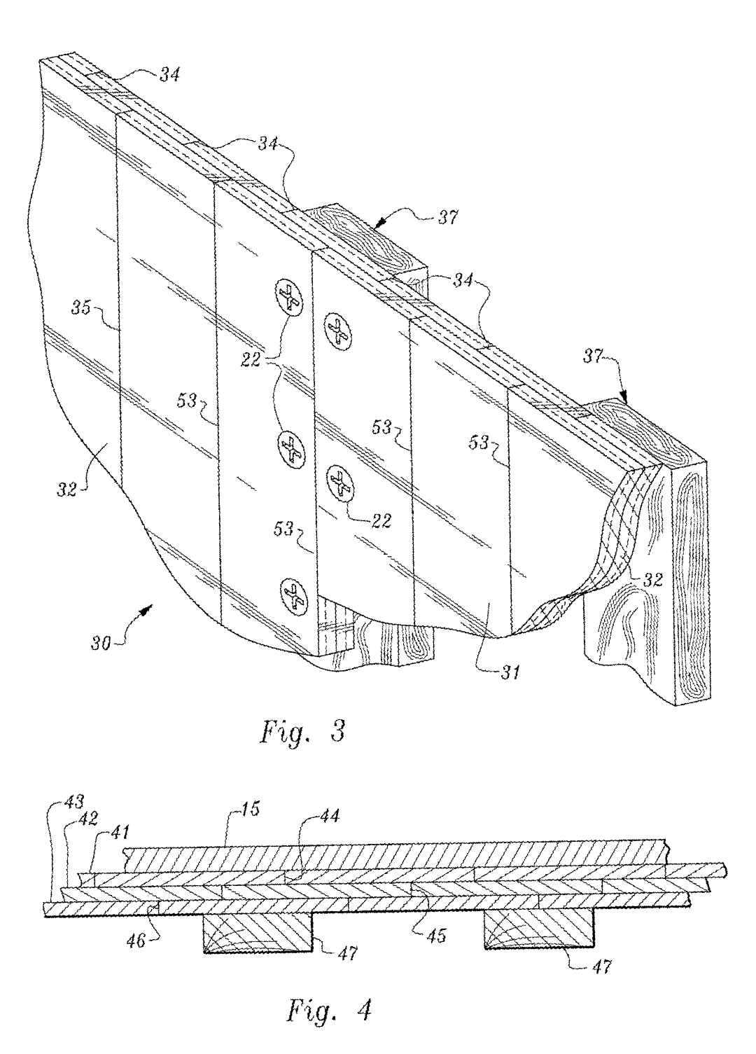

Thus the invention concept is demonstrated in FIG. 3 by wall 30, where two panels 31 and 32, each having a plurality of plies (unnumbered separately) but with the concept of the plies represented by the dashed lines, are shown in a staggered formation. The first or front layer has a multiplicity of sheets 31 abutted at locations 35, while the sheets 32 in the interior disposition are abutted at locations 34. The rectangular elongated member 37 shown in FIG. 3 is not a batten, but is the wood 2′×4′ used in forming the structure of the building and which is fastened directly to the ballistic panels.

A bullet, when fired at exactly the junction of the front two adjacent ballistic sheets of an installation of stacked sheets, would slow down adequately such that the subsequent sheets would serve to prevent the penetration into the protected zone. The protection afforded would be the same if one stood directly behind a location of an area within the middle of the front lower level sheet as at the junction of two adjacent lower level sheets. The stopping ability of the remaining staggered lower level sheets thus prevents the penetration.

From a top plan perspective reference is made to FIG. 2, which is also a prior art depiction. Here the monolithic thick multi-ply panel 11 is seen to be faced with plywood 15. The ballistic panel 11 is secured at the seam of two adjacent panels to battens 13, which in turn are attached to building structural members such as studs, 17.

Compare FIG. 2 to FIG. 4 which is a diagrammatic illustration of this invention. This figure is used to illustrate the concept of the invention and is not representative of an actual permutation of any specific level of ballistic protection according to this invention. Here three different layers of discrete lower level of protections sheets designated 41, 42, and 43 are placed end to end in a staggered pattern, with the respective layer's seams designated as 44, 45 and 46 being off set relative to each other. The top most layer is again a decorative layer such as gypsum board 15, while the lowermost is the structural stud 47. It can be seen that the additive thickness of 41, 42, 43 is substantially the same as or greater than the single monolithic thick panel 11, and as such it is anticipated that the protection level from the installation of FIG. 4 will be the same as that of the single panel 11 of FIG. 3. The provision exists however that each of the individual fibreglass sheets is a UL listed ballistic resistant sheet for the specific level of protection recited.

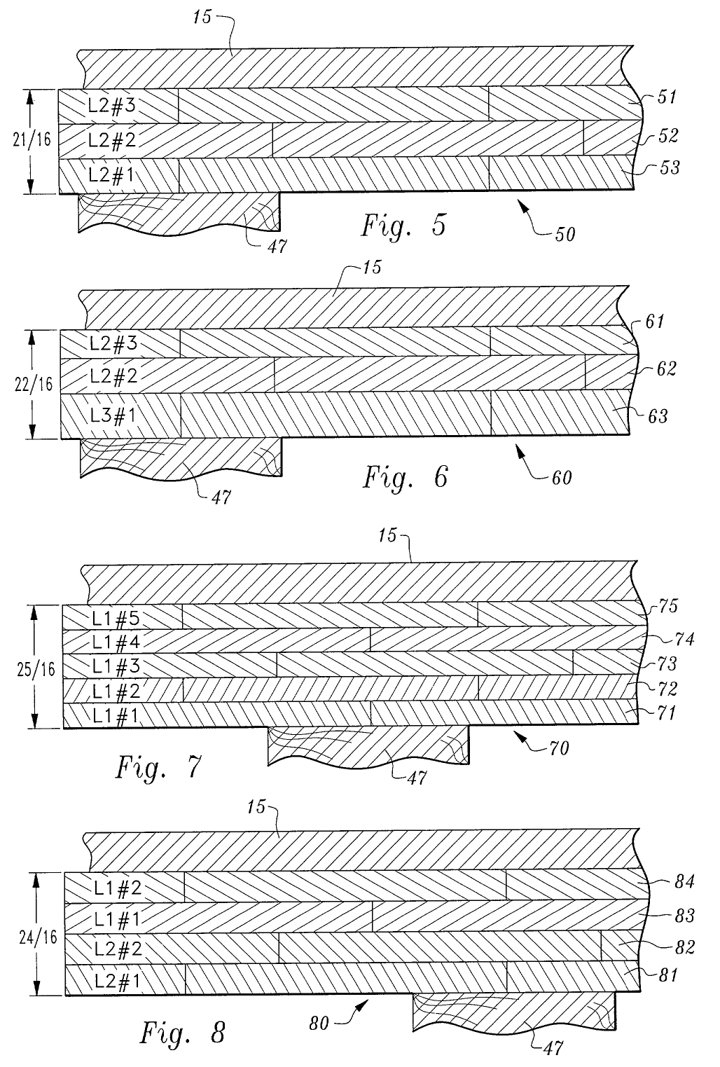

It is to be understood that for the purposes of the discussion of FIGS. 5 through 8, that layer 15, the gypsum wall or other decorative material such as paneling, is on the outside of the protected zone. It is also to be assumed that designator 47 may be a metal or wood stud, and that only one of such is shown in the figures for simplicity. It is further to be assumed that for cosmetic purposes, an interior non-ballistic resistant layer will more than likely be interposed between in the innermost layer of ballistic material and the studs 47. But again for simplicity such is not shown.

The reader is now directed to FIG. 5 which is a graphic illustration of another example according to this invention. Here, the wall of protection 50, is three layers of UL listed Level 2 ballistic resistant fibreglass, designated 51, 52, and 53. These are physically placed in a staggered format as shown and screwed to studs 47, usually at 16 to 24 inches on centre spacings. The combined thickness of these Level 2 rated sheets is 21/16. The level of protection achieved here is Level 4. In contrast a single Level 4 UL listed monolithic panel is 19/16 inches thick.

In FIG. 6, it was desired to achieve a protection level of Level 5 by wall 60. The thickness of a UL listed Level 5 panel is 1.375 or 22/16 inches. To achieve this level, three sheets were screwed in staggered fashion to the studs. The three individual panels are designated 61, 62, and 63 respectively and are Level 2 #2, Level 2 #1 and the most interior sheet is a Level 3 rated sheet. Since like numbers refer to like parts, 15 and 47 refer to the outside the zone decorative wall material and the interior studs. Each Level 2 sheet is 7/16 inches thick and the Level 3 sheet has a thickness of ½ inch. The combined thickness therefore is 22/16. It has been found that if a combination of different levels of protection sheets are used to achieve a higher level of protection that the higher level sheets should be used closer to the interior of the protected zone. Thus, as shown in this figure. The Level 3 sheet is the innermost layer. Ballistic testing confirms that the needed resistance to match that of a monolithic panel can only be obtained when the higher level sheet(s) is placed interiorly.

FIG. 7 illustrates another combination of a multiplicity of staggered sheets, 70. Here five sheets of UL Level 1 rated ballistic fibreglass each having a nominal thickness of 5/16 and designated 71 through 75 are stacked in a staggered formation as aforesaid for attachment to the stud 47. A UL Level 4 of protection would be achieved, since a Level 4 panel is 1.375 or 24/16 inches thick.

FIG. 8 illustrates yet another Level 4 zone of protection, 80. Here 2 Level 1 s and 2 Level 2s are used and being designated 81 through 84 interiorly to exteriorly. Each Level 1 being 5/16 inches thick. Each Level 2 having a nominal thickness of 7/16. A total thickness of 24/16 should provide the protection of a single Level 4 panel as well. Note again that the higher level panels are positioned toward the interior.

The following shooting data illustrates the fact that Level 5 protection can be achieved by the use of the staggered placement of a plurality of sheets of the various lower levels of protection with the caveat that lower levels are disposed forwardly toward the exterior of the protected zone formed from these combinations of sheets of Level 1, Level 2, and Level 3 UL listed ballistic fibreglass as are recited in the specific examples.

### Example 1

Level 5 protection requires that the substrate be resistant to 1 shot of a 7.62 mm rifle lead core full metal copper jacket shell, mil ball, discharged at a velocity of 2750 fps. When a plurality of sheets of ballistic fibreglass the sum of whose thicknesses equal or exceed the thickness required of a monolithic single sheet of Level 5 ballistic fibreglass were placed sequentially in a staggered position such that one seam was never directly behind a second abutted seam and the weapon of choice was fired in accordance with the predefined standard to achieve Level 5 protection at the series of sequentially stacked and staggered sheets of fibreglass, penetration was not achieved and the person who would have been behind the rear most sheet would not have been hurt by the firing of the weapon.

### Example 2

The test for Level 8 protection requirement is the same as Level 5 but for five shots not one. When a series of lower level protection ballistic fibreglass sheets, all within the range of Level 1, Level 2, and Level 3, were placed in predefined combinations conceived to achieve a certain level of protection based upon the sum of the thicknesses of the plurality of panels matched to the thickness of a known single monolithic layer rated for a specific level of ballistic protection; and were placed in a staggered position such that no two abutted sheets were directly behind each other but the abutments were staggered, it was found that the zone of protection was maintained when the weapon of choice of the UL standard was fired at the stacked sheets of ballistic fibreglass.

In the creation of Tables 1 and 2, a comparison was made of the sum of the thicknesses of the various combinations of UL listed Level 1, Level 2, and Level 3 ballistic fibreglass versus the thickness of a monolithic single panel of the desired protection level. In Table 1 that level is Level 5. The numbers in the respective Level's column corresponds to the number of sheets of the respective level to be overlaid to achieve the desired level of protection, Level 5, Level 7 and Level 8, as noted in the far right column of Table 1, and the achievement of protection of UL listed Level 4 in Table 2.

TABLE 1
In the table set forth below, ballistic resistance to Level 5 previously
defined, Level 8 previously defined, and Level 7 which is the ability to
resist five shots from a 5.56 mm rifle full metal copper jacket with lead
core having forty-four grains and a velocity of 3080 fps, were all achieved
by the overlaying of the recited number of sheets of Levels 1, 2, and 3 of
UL listed ballistic fibreglass in an offset pattern as discussed herein.
A significant saving of time, shipping weight, and cost were achieved.

| | | | | EQUIVALENT |
|---|---|---|---|---|
| | | | | LEVEL OF |
| LEVEL 1 | LEVEL 2 | LEVEL 3 | THICKNESS | PROTECTION |
| | 2 | 1 | 22/16 OR 1.38 | 5, 7 |
| 5 | | | 25/16 OR 1.56 | 8 |
| 4 | | | 20/16 OR 1.25 | 5, 7 |
| 2 | 2 | | 24/16 OR 1.50 | 8 |
| 3 | 1 | | 22/16 OR 1.38 | 5, 7 |
| 1 | 1 | 1 | 21/16 OR 1.31 | 20/16 (less) |
| 2 | | 1 | 19/16 OR 1.19 | 18/16 (less) |
| | 1 | 2 | 23/16 OR 1.56 | 23/16 (less) |
| 1 | | 2 | 21/16 OR 1.31 | 5 |
| | 3 | | 21/16 OR 1.31 | 5 |
| | | 3 | 24/16 | 8 |

### TABLE 2

The concept of this invention can also be applied to achieve a Level 5 of ballistic protection. It should be understood that both a Level 4 and a Level 5 resistant sheet of ballistic fibreglass are of the same nominal thickness of 22/16. Level 4 requires resistance to a single shot from a .30 caliber rifle lead core soft pont bullet with 180 grains fired at 2540 fps. Level 5 is more stringent.

Table 2 recites various permutations of combinations of the recited number of sheets of UL rated Level 1, Level 2, and Level 3 ballistic fibreglass to achieve at least Level 5 protection. Here as with Table 1, savings were achieved due to fewer number of installers needed due to lesser weight per panel, lower shipping charges, and ready availability of materials, yet the same level of protection was obtained as with a single monolithic panel of Level 5 material.

TABLE 2

| | | | | EQUIVALENT |
|---|---|---|---|---|
| | | | | LEVEL OF |
| LEVEL 1 | LEVEL 2 | LEVEL 3 | THICKNESS | PROTECTION |
| 5 | | | 25/16 or 1.56 | 8 |
| 4 | | | 20/16 or 1.25 | 5, 7 |
| 2 | 2 | | 24/16 or 1.50 | 8 |
| 3 | 1 | | 22/16 or 1.38 | 5, 7 |
| 1 | 1 | 1 | 20/16 or 1.25 | 5, 7 |
| 2 | | 1 | 19/16 or 1.19 | 18/16 (less) |
| | 1 | 2 | 23/16 or 1.43 | 8 |
| 1 | | 2 | 21/16 or 1.31 | 5 |
| | 3 | | 21/16 or 1.31 | 5, 7 |

In Tables 1 and 2, the comparisons made of combinations of sheets of UL listed Levels 1, 2 & 3 ballistic fibreglass were made against higher level monolithic panels of the same manufacturer, designated MAKER A who uses his own proprietary process for manufacturing the individual sheets and panels.

When a testing program was run using sheets of UL listed ballistic fibreglass of MAKER B, and the sum of the various thickness combinations were checked against monolithic panels of the same manufacturer, namely MAKER B similar results of achievement of higher levels of protection were obtained. It is to be noted however, that due to the fact that MAKER B apparently uses a different formulation and/or processing procedure for his sheet and panel manufacture, that MAKER B can achieve the test results needed to obtain UL listings at the respective levels for his sheets and panels even though his nominal thicknesses are smaller than the nominal thicknesses of MAKER A.

In conclusion therefore, it is seen that the concept of this invention that the sum of thicknesses from staggered placement of lower level UL listed ballistic fibreglass to match the higher protection levels of heavy monolithic sheets can only be made within the reference framework of the same manufacturer of the sheets and panels.

For example it was found that seven staggered sheets of MAKER B's Level 1 listed product had a nominal thickness of 21/16, yet it achieved the same performance of the Level 8 product of this manufacturer which is also 21/16 inches thick. In contrast, MAKER A's Level 8 listed product is 23/16 inches thick, for Level 8 and 7 sheets of Level 1 would be 35/16 inches thick

This is again borne out by the fact that three sheets of Level 3 of MAKER B is 21/16 inches thick and achieved a Level 8 protection level, while three sheets of MAKER A's product are 24/16 inches thick.

Little discussion has been set forth about Level 4 of protection. Panels of monolith of UL listed Level 4 are 1.375 inches thick for one manufacturer, which coincides with the thickness of that company's Level 5 product. The distinction being that the ballistic resistance for Level 4 is one .30 caliber bullet, but for Level 5 it is one 7.62 mm full metal jacket military bullet. From a practical point of view, manufacturers do not distinguish between Level 4 and Level 5 panels. In the same spirit, the ballistic requirements for Level 6 are greater than those of Level 2, but the nominal thickness of both panels is the same for any one manufacturer.

The staggering of the sheets overlaid, for the tables above and in actual use in particular, is generally set at sixteen to twenty-four inches apart because this is the spacing used in the creation of walls behind which persons work in that wood joists or steel joists are commonly placed sixteen to twenty-four inches apart. The actual choice of the staggered distance apart is determined at the time of the implementation of the protection zone. The reader is advised that in most situations ballistic fibreglass is applied to walls rather than directly to furniture such as desks or bookcases.

However, furniture such as desks and bookcases can be protected in like manner. The wood of the furniture, the wood of the joist or the steel of the joist, behind any wallboard (gypsum board) offers zero ballistic protection. Reference is made therefore to FIG. 4, which shows a series of ballistic fibreglass sheets 41, 42, and 43 disposed upon the framing 47 of a room with standard gypsum board 15 disposed in front of the ballistic fibreglass to hide the fact that a zone of protection exists. This would be the construction utilized in a typical self-serve gas station where the attendant would be standing behind a protected counter. The clear bullet resistant glass would extend from the height of the counter to the ceiling. Such an installation can also be used at a bank or check cashing agency. If this was a special executive office the layers, shown in FIG. 4, would extend from floor to ceiling.

The contrast between the mode of installation of this invention and the prior art modes of FIG. 2, seen in top view and previously discussed, also is readily seen. The layers again constitute 15 the gypsum board; 11 is the monolithic panel of the ballistic fibreglass, 14 is the batten of fibreglass, and 17 is the wood framing of the room. The actual depth used by the prior art may be significantly larger and invade the usable space of the room depending on the mode of installation.

All fibreglass panels are held in a face to face relationship by fasteners such as 22 seen in FIGS. 1 and 3. A quite suitable fastener is a wafer head coated steel screws. These are available in the marketplace from various vendors.

It is seen that there has been disclosed a new technique for reducing the cost of installation of ballistic fibreglass protection zones as compared to the costs associated with the installation of monolithic thick panels. While both the monolithic panels and the sheets are made of multi-plies, sheets require fewer people to move and to install them due to significantly lower weight. Thus, time is saved, storage space for the installer is saved, freight costs are reduced due to less handling, yet the protection level achievable by staggered combining of a particular manufacturer's UL listed lower level products to achieve the desired higher levels of protection can be obtained.

Since certain changes may be made in the described apparatus without departing from the scope of the invention herein involved, it is intended that all matter contained in the above description and shown in the accompanying drawings shall be interpreted as illustrative and not in a limiting sense

What is claimed is:

1. A process for creating a ballistic resistance protection zone achieving higher Underwriters Laboratory listed levels of ballistic resistance, from rows of sheets of UL listed Level 1, Level 2 and Level 3 ballistic resistant fibreglass which process comprises:
a. Determining the UL level of protection desired of ballistic resistance;
b. determining the thickness of a single monolithic panel of UL listed ballistic fibreglass listed by UL as achieving the desired level of resistance of a specific manufacturer;
c. adding the sums of the nominal thicknesses of a plurality of sheets of ballistic fibreglass of the same specific manufacturer which fibreglass sheets are listed by UL as being any and all of UL listed Levels 1, 2 and 3, of the same manufacturer; and
d. if the sum of the thicknesses of the said plurality of sheets is at least equal to the nominal thickness of the monolithic panel affording the level of ballistic protection desired, then installing the individual sheets in a staggered formation such that the adjacent abutment of any two adjoining sheets in a first row is spaced laterally from the lateral abutment of adjoining sheets in any other row.

2. The process of claim 1 wherein the desired level of protection is Level 4 and the sum of the thicknesses of the plurality of sheets of UL listed Level 1, 2, and 3, ballistic fibreglass is at least the thickness of a monolithic panel of ballistic fibreglass of the same manufacturer of the same UL level.

3. The process of claim 1 wherein the desired level of protection is Level 5 and the sum of the thicknesses of the plurality of sheets of UL listed Level 1, 2, and 3, ballistic fibreglass is at least the thickness of a monolithic panel of ballistic fibreglass of the same manufacturer of the same UL level.

4. The process of claim 1 wherein the desired level of protection is Level 8 and the sum of the thicknesses of the plurality of sheets of UL listed Level 1, 2, and 3, ballistic fibreglass is at least the thickness of a monolithic panel of ballistic fibreglass of the same manufacturer of the same UL level.

5. The process of claim 1 wherein if sheets of more than one level of ballistic fibreglass are used in preparing the protection zone, including the step of placing the sheets of the highest UL listing level toward the interior of the protection zone.

6. A zone of ballistic resistant zone of protection wall having a ballistic resistance level of any of UL Levels 4, 5, and 8 comprising a plurality of rows of adjacent abutted sheets of UL listed ballistic fibreglass of fibreglass sheets having a UL listing of any of UL Level 1, UL Level 2, and UL Level 3 wherein the abutment of any two sheets of fibreglass is spaced from the abutment of any two sheets in any other row;
said rows of sheets being fastened together by conventional fasteners through all the rows of ballistic fibreglass.

7. The zone of protection of claim 6 wherein the rows of fibreglass are fastened directly to conventionally spaced studs without the use of battens behind the rearmost row.

8. The zone of protection of claim 6 wherein the rows are formed of at least two different levels of UL listed ballistic fibreglass, and wherein the highest level listed row(s) are disposed toward the interior of the protection zone.

9. The zone of protection of claim 8 wherein the fibreglass sheets are a combination of Levels 1 and 2 and the Level 2 sheets are placed toward the interior of the zone of protection.

10. The zone of protection of claim 8 wherein UL listed sheets of Levels 1, 2, and 3 are employed in the construction of the protection zone.
